(19) United States
(12) Patent Application Publication
(10) Pub. No.: US 2002/0103585 A1
(43) Pub. Date: Aug. 1, 2002

(54) Locomotive data management system and method based on monitored location

(76) Inventors: Lawrence J. Biess, Jacksonville, FL (US); Ted E. Stewart, Jacksonville, FL (US)

Correspondence Address: DRAUGHON PROFESSIONAL ASSOCIATION, ONE INDEPENDENT DRIVE, SUITE 2000, JACKSONVILLE, FL, 32202, US

(21) Appl. No.: 09/845,564

(22) Filed: Apr. 30, 2001

Related U.S. Application Data
(63) Continuation-in-part of application No. 09/773,072, filed on Jan. 31, 2001.

(51) Int. Cl. G06F 17/00; G01C 21/26

(52) U.S. Cl. 701/35; 701/19; 701/207

(57) ABSTRACT

A system and method for monitoring a locomotive system comprising at least one internal-combustion engine. Specifically, the present invention enables monitoring and compiling of locomotive systems operation data and location data to be used in a variety of useful functions, such as emissions monitoring or accident reconstruction. A geographic position determination unit generates location information. A plurality of sensors are appended to a locomotive system to monitor locomotive system features, including brake-line pressure, external temperature, engine temperature, and the like. Such sensors are coupled to a locomotive computer to enable data processing and transmission to a system user.

### RELATED APPLICATION

This application is a continuation-in-part of co-pending and co-owned U.S. application Ser. No. 09/773,072 entitled SYSTEM AND METHOD FOR SUPPLYING AUXILIARY POWER TO A LARGE DIESEL ENGINE, which is hereby incorporated by reference for all purposes.

### BACKGROUND OF THE INVENTION

1. Field of the Invention

The present invention pertains to large engine systems, but more specifically to a system and method for collecting and managing locomotive engine data based on monitored location. In particular, this invention relates to an electronic tracking system for monitoring and generating valuable locomotive data, such as the geographical location of a locomotive at any time, the working status of at least one locomotive engine, the fuel level of the locomotive and other operational features of a locomotive unit.

2. Background of Related Art

In locomotives, constant system monitoring and maintenance is very important. Failure to properly monitor a locomotive system could result in serious damage, costly repairs, and significant operational delays. Monitoring both operational and location information of a locomotive system is useful for a plurality of functions. Specifically, such information is useful for earning emissions credits, abiding by local restrictions, reconstructing accidents, and the like.

For example, the EPA promulgates emissions standards governing locomotive emissions of oxides of nitrogen (NOx), hydrocarbons, carbon monoxide, particulate matter, and smoke. The EPA monitors compliance with its regulations essentially by requiring those individual companies whom it has licensed to discharge emissions at a certain rate to monitor such discharges and to maintain records of such discharges for reporting to and review by the EPA. Moreover, several states have instituted individual requirements to limit emissions, particularly in susceptible areas or critical seasons or during specific operations, such as idling.

Continuously monitored locomotive operation based on locomotive position additionally facilitates accident reconstruction. Because current locomotive systems do not include a means for constantly monitoring locomotive operational activity derived from location information, the present means for reconstructing accidents involves a physical investigation of the accident site and analysis of such sites. Often such analysis is based on circumstantial evidence derived from the accident site, such as skid-marks, visibility studies for obstructed views, day and night visibility studies, driver reaction time, weather effects, and the like. Reconstruction of locomotive accidents is both time and cost intensive. Alternatively, constant monitoring of operational data up to the accident, including location pinpointing, provides useful data to greatly facilitate accident reconstruction analysis.

Available systems generally only monitor locomotive position in conjunction with particular fields of locomotive operation. For example, a current system monitors locomotive position while concurrently controlling fueling of an internal combustion engine. The system, however, does not monitor such operational features as exhaust temperature, intake temperature, oil levels, and coolant temperature in relation to monitored locomotive position. It is apparent from the above system that there exists a need in the art for a system for monitoring and gathering data regarding locomotive operation based on locomotive location.

Prior systems provide a satellite system for locating a rail vehicle using trackside transponders, track circuits and wheel tachometers. Such a system possesses several serious drawbacks. Foremost, the system does not include a system for gathering operational locomotive data to monitor such activity as emission output or systems operation soundness. Moreover, to effectively use this system, additional rail circuitry and components such as wheel tachometers and track circuits, are required. An additional disadvantage to this system is the expense, time and manpower required for system installation.

Another system presently utilizes a GPS positioning system for emissions control in trucks having smaller engines. The system accounts ambient air quality based on truck location to calibrate and adjust exhaust emissions by modifying electronic fuel injection to the truck's engine. This system has a weakness in that it does not accurately and automatically account for all operative activities in a large locomotive system. More importantly, this system disregards other factors relevant to locomotive emissions such as idle time.

Additionally, none of these references suggests or discloses monitoring specific data based on locomotive location to obtain emission credits from the EPA, monitor locomotive activity in relation to local/state restrictions, or supply an accurate and time-efficient means for accident reconstruction analysis.

### SUMMARY OF THE INVENTION

Therefore, it is apparent from the above that there exists a need in the art for a system and method of monitoring locomotive operational activities based upon location. It is a purpose of this invention, to fulfill this and other needs in the art.

An object of the present invention is to provide a system and method for monitoring and communicating both operation and location information of a locomotive system.

Another object of the invention is to provide a means for precisely locating the geographical location of a locomotive system.

Still another object of the invention is to enable monitoring of any locomotive operational activity.

A related object of the present invention is to provide a system and method for tracking a locomotive system having an auxiliary power supply system to allow for shutting down a primary diesel engine in all weather conditions. A more specific object of the present invention is to enable a tracking system and method for conveying to a user the length of time a primary locomotive engine has remained stationary and will experience shut down. Such tracking enables either automatic or manual initiation of an auxiliary unit upon primary engine shut down.

An additional object of the invention is to provide for a database management system that monitors valuable locomotive systems data, which could be used to obtain emission credits from the EPA.

Another object of the invention is to provide a database management system to compile and monitor valuable locomotive operational and location data applicable to accident reconstruction analysis.

Another object is to enable a data management system and method for monitoring and reporting any locomotive engine operational features, including fuel levels to generate efficient fueling decisions, brake-line air pressure, oil temperature and pressure, battery life, and so forth.

Another object of the invention is to enable monitoring of locomotive system features, including external environmental factors and the like.

Yet another object of the present invention is to enable means for notifying a user of locomotive arrivals and departures for improved terminal flow. A related object is to provide a means for reporting locomotive position.

The above-mentioned objects are met by the present invention, which provides a system and method for electronically compiling and monitoring locomotive systems operation and location. A system according to the present invention includes one or more sensors, a means for determining locomotive location, and a computer within a locomotive unit for gathering operational and location data. Specifically, a geographic position determination unit is included in the system to survey locomotive location. The computer within the locomotive unit is preferably coupled to the sensors and possesses the ability to relay sensor data either to a locomotive operator or off-site to a system user to process the data into information for calculating EPA emission credits or aiding in accident reconstruction analysis, and so forth.

In a specific embodiment of the present invention, a system and method is enabled to monitor operation and location activity of a locomotive system possessing a means for automatic weather layover protection. Specifically, the system includes a symbiotic auxiliary engine to enable freeze and heat protection of primary engine systems and cab components. Prior solutions did not include primary and auxiliary locomotive engines with a data management system. The present invention specifically provides a means for compiling data on running time, idling time, and shut down time of each engine. Such data is used to calculate reductions in fuel consumption, NOx emissions, and other reductions in environmental hazards as a result of using an auxiliary engine in combination with a locomotive engine. The reductions can be used to obtain emission credits from the EPA. These credits can be exchanged with other commodities or currency.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a high level schematic representation of the data management system according to the present invention;

FIG. 2 is a diagram of an embodiment of a system consistent with the present invention, in which monitored information is processed in accordance with the present invention; and

FIG. 3 is a combination schematic and block diagram of an embodiment of a locomotive data management system consistent with the present invention.

### DETAILED DESCRIPTION OF THE INVENTION

The invention summarized above and defined by the enumerated claims may be better understood by referring to the following detailed description, which should be read in conjunction with the accompanying drawings in which like reference numbers are used for like parts. The present invention may be applied in connection with any locomotive system having an auxiliary unit. To facilitate an understanding of the application of the invention to a locomotive including an auxiliary unit, some pertinent aspects of an auxiliary unit are first reviewed. Those skilled in the art should appreciate that they may readily use the conception and specific embodiments disclosed as bases for modifying or designing other methods and systems to carry out the same purposes of the present invention. Those skilled in the art should also realize that such equivalent assemblies do not depart from the spirit and scope of the invention in its broadest form.

The present technology is applicable to a variety of locomotive engine systems. According to the present invention, an engine system is provided preferably having one or more sensors placed within and without a locomotive unit. Such sensors relay to either the locomotive operator or system user current engine operating conditions. Sensors can be any of a variety of devices dependent on the particular data being addressed. For instance, the sensors can comprise temperature sensors such as thermocouples or resistance temperature detectors (RTD). The sensors can also include vibration, speed, pressure, fuel, frequency, voltage, current or pressure sensors. Sensors are positioned within a locomotive's diesel engine to sense actual operational data such as oil temperatures, inlet air conditions such as temperature, or internal and external pressures.

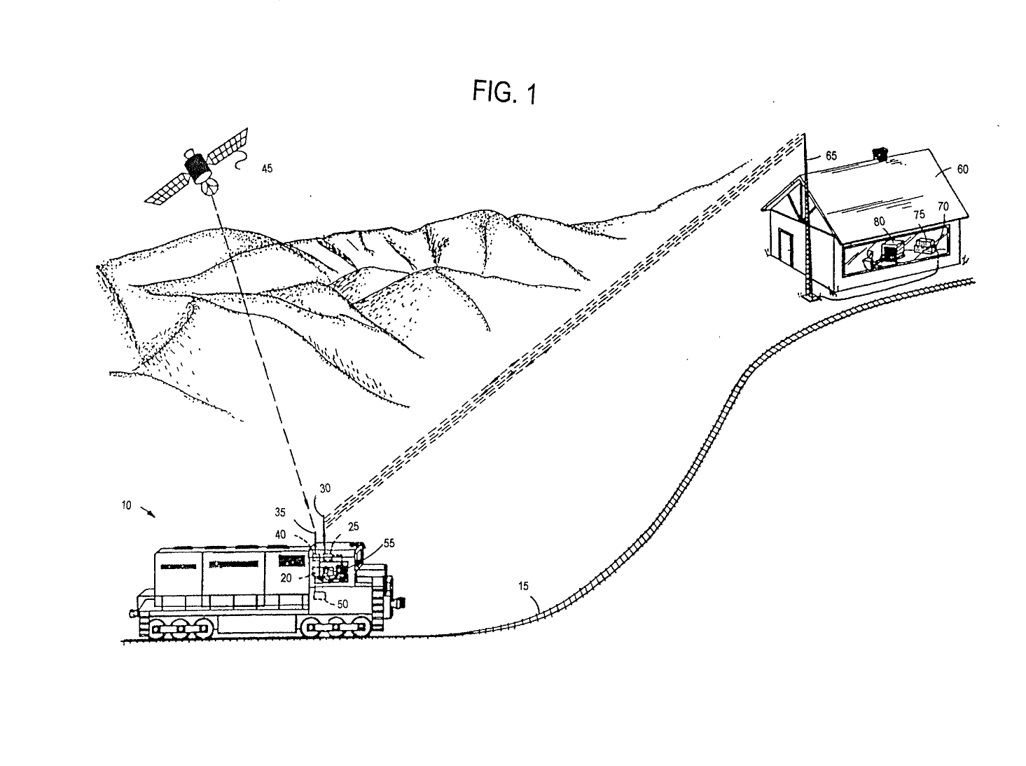

Referring to FIG. 1, which represents a schematic illustration of a database management system consistent with the present invention, locomotive 10 is located on railroad track 15. Locomotive 10 is shown having locomotive computer (LC) 20 which is coupled with communication means 25 having antenna 30.

Locomotive computer 20 preferably has PC hardware capable of performing numerous variable functions, which are necessarily variable to accommodate different locomotive types, communication systems, and the like. Communication means 25 is preferably capable of transmitting and receiving data signals at a relatively high data rate, such as a wireless communication system, radio system, or the like. Locomotive computer 20 is also connected to a geographic position determination antenna 35 and geographic position determination receiver 40 in communication with a geographic position determination unit (GPDU) 45. GPDU 45 provides location information using such means as a space based GPS-type satellite platform, a device performing triangulation calculations, or a device that performs time-delay distance calculations. Other suitable means may also be employed. According to FIG. 1, GPDU 45 is schematically illustrated transmitting a signal. Consistent with the invention disclosed in the referenced U.S. Pat. No. 5,129,605 entitled “Rail Vehicle Positioning System” by Burns et al., GPDU 45 generates, tracks, and relays location data for locomotive 10.

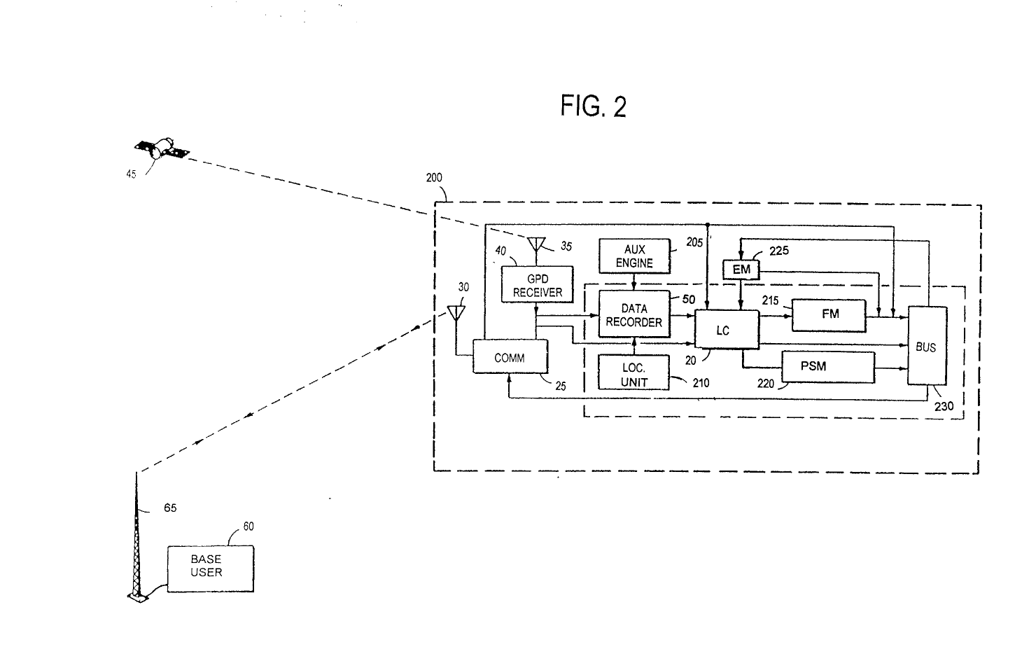

Also according to FIG. 1, locomotive computer 20 is connected to data recorder 50 to monitor locomotive operational system activity. Data recorder 50, described in further detail in the following FIG. 2, possesses information inputs, coupled to a plurality of sensors, to receive information regarding locomotive system activity. A locomotive interface 55 is preferably coupled with locomotive computer 20 to provide an interactive display device for receiving and transmitting information from as well as displaying information to the locomotive operator.

Also according to FIG. 1, communication means antenna 30 and communication means 25 through locomotive computer 20 relay information compiled in data recorder 50 to base user 60 through base antenna 65 and base receiver 70. Base user 60 accesses transmitted information from data recorder 50 via base computer 75, which is preferably coupled to a display console 80. Base computer 75 preferably includes PC hardware, similar to locomotive computer 20 which is capable of performing numerous variable functions, which are necessarily variable to accommodate different locomotive types, communication systems, and the like.

In operation, as illustrated in FIG. 2, an embodiment of the present invention enables GPDU 45 to transmit operation and location information signals regarding locomotive 10 having a primary locomotive engine and an auxiliary engine. Exterior dashed line 200 represents the equipment on board locomotive 10 (FIG. 1). Typically, GPDU 45 generates location signals transmitted to base user 60 via equipment on board locomotive 10. Such location determination signals are preferably relayed to data recorder 50 to be processed into constructive data by locomotive computer 20. In addition to gathering location signals, data recorder 50 receives operational activity signals generated by sensors coupled to locomotive and auxiliary engine 205 and locomotive unit 210. Data recorder 50 compiles all information from GPDU 45, locomotive and auxiliary engine 205, and locomotive unit 210, and transmits such information to locomotive computer 20. Locomotive computer 20 preferably processes such information for use by a locomotive operator or base user 60 in monitoring geographical location, emission levels, fuel levels, and the like, of the locomotive system.

Information regarding locomotive location, operational activity of locomotive and auxiliary engine 205 and operational activity of locomotive unit 210 are processed by locomotive computer 20 and routed to such application programs as fuel manager (FM) 215, position/speed manager (PSM) 220, and emission manager (EM) 225. Fuel manager 215, position/speed manager 220, and emission manager 225 all utilize location information generated by GPDU 45 and operational activity information generated by locomotive and auxiliary engine 205 and operational activity of locomotive unit 210 to determine and relay fuel level information, locomotive speed, and location information to either the locomotive operator or base user 60.

Information generated by fuel manager 215 and position/speed manager 220 are preferably delivered via bus 230 to emission manager 225 to be processed into accurate emission information, useful in calculating EPA emission credits. Once emission manager 225 processes information from both fuel manager 215 and position/speed manager 220 based on location information, the emission information is preferably transmitted to either locomotive computer 20 for use by the locomotive operator or to bus 230 to be dispatched to base user 60.

Specifically, emission manager 225 preferably operates by processing different valuable information about locomotive and auxiliary engine 210, such as EPA emission data, locomotive and auxiliary engine 205 data, and overall locomotive unit data 210. The EPA emission calculations require data regarding locomotive and auxiliary engine 205. Such data includes geographical location, run status at each geographical location, and idle time. Such data may be recorded every hour or half an hour. Data compiled regarding either locomotive or auxiliary engine 205 includes run time status at each geographical location, the start time, and the ambient temperature at the time auxiliary engine 205 began functioning. Other data may also be utilized such as the speed of the locomotive, the fuel level and so forth.

Bus 230 preferably dispatches information processed by fuel manager 215, position/speed manager 220, and emission manager 225 to base user 60 via communication means 25 and antenna 30. Such information is received and transmitted to base user 60 through base antenna 65 and base computer 75. Alternatively, bus 230 may transmit only fuel manager 215 and position/speed manager 220 processed information to base user 60 via base computer 75. As such, base computer 75 preferably has an emission manager 225 application program for processing the relayed information into useful emission data. Such emission data is useful for base user 60 in managing locomotive emission as mandated by the EPA.

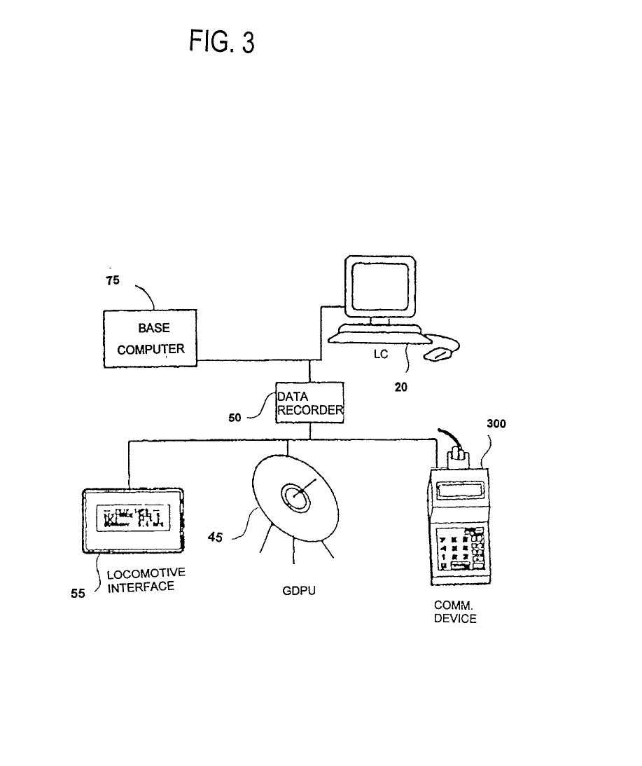

FIG. 3 discloses an alternate embodiment wherein either GPDU 45 or the locomotive operator may relay locomotive location information to data recorder 50. Specifically, the locomotive operator may relay location information via locomotive interface 55 or via a communication device 300. Communication device 300 preferably includes a wireless communication unit such as a cellular phone, personal digital assistant, or similar device capable of transmitting information to a computer. Once location information is delivered to data recorder 50, data on locomotive fuel, location, speed and emission are generated by locomotive equipment 200 as illustrated in the preceding description of FIG. 2.

An alternate embodiment of the present invention enables a means for monitoring operational activity and location data of an improved locomotive system having an auxiliary power unit. This improved system enables a methodology that reduces environmental emissions. In particular, such system provides heating or cooling and electricity to a railroad locomotive in all operating environments, while conserving locomotive fuel and lubricating oil. The auxiliary power unit of this improved system preferably includes a diesel engine coupled to an electrical generator. The improved system preferably monitors both locomotive position and various modes of auxiliary power unit operation.

During normal operation of a railroad locomotive engine, the auxiliary power unit is not in operation. The improved system preferably includes an engine operation sensor and timer to determine the mode of engine operation and length of time the engine operates at such mode. For example, such engine operation sensor preferably monitors whether the primary locomotive engine has been inoperative for a predetermined period of time. The engine operation sensor and timer preferably relays information regarding the mode of engine operation and length of time the engine operates at such mode to the data recorder 50 (FIG. 1). Concurrently, data recorder 50 compiles locomotive location information relayed by GPDU 45. In an embodiment of the present invention, all information relayed to the data recorder 50 from the GPDU 45 and the engine operation sensor and timer are communicated to emission manager 225 (FIG. 2) to be processed into accurate emission information, useful in calculating EPA emission credits.

Where a primary locomotive engine remains idle for a greater length of time than the predetermined period, the auxiliary power unit is automatically activated to operate in a plurality of modes by a control system, as described in co-pending and co-owned U.S. patent application Ser. No. 09/773,072 entitled SYSTEM AND METHOD FOR SUPPLYING AUXILIARY POWER TO A LARGE DIESEL ENGINE.

An auxiliary power unit preferably includes a “thermostat” mode for protecting the primary engine from ambient cold weather conditions, while reducing emissions. In “thermostat” mode, the control system shuts down the primary locomotive engine after a predetermined period of inactivity and idle operation, and starts the auxiliary power unit to warm locomotive engine systems. When the auxiliary power unit is activated, the engine operation sensor and timer preferably determines the length of time the auxiliary power engine operates at such mode and relays such information to data recorder 50 (FIG. 1). Concurrently, data recorder 50 compiles locomotive location information relayed by GPDU 45. In an embodiment of the present invention, all information relayed to the data recorder 50 from the GPDU 45 and the engine operation sensor and timer are communicated to emission manager 225 (FIG. 2) to be processed into accurate emission information, useful in calculating EPA emission credits.

In addition, an auxiliary power unit preferably includes a “cab” mode to shut down the primary engine during warm weather operation to minimize pollutant emissions and maximize fuel savings. In “cab” mode, the control system automatically shuts down the primary locomotive engine after a predetermined period of inactivity and idle operation. In an alternate embodiment of the present invention, the auxiliary power unit is preferably activated manually or automatically based on a monitored environmental condition. When the primary locomotive engine is shut down, the engine operation sensor and timer preferably determines the length of time such engine remains inactive and relays this information to data recorder 50 (FIG. 1). Concurrently, data recorder 50 compiles locomotive location information relayed by GPDU 45. In an embodiment of the present invention, all information relayed to the data recorder 50 from the GPDU 45 and the engine operation sensor and timer are communicated to emission manager 225 (FIG. 2) to be processed into accurate emission information, useful in calculating EPA emission credits.

While specific values, relationships, materials and steps have been set forth for purposes of describing concepts of the invention, it should be recognized that, in the light of the above teachings, those skilled in the art can modify those specifics without departing from basic concepts and operating principles of the invention taught herein. Therefore, for purposes of determining the scope of patent protection, reference shall be made to the appended claims in combination with the above detailed description.

What is claimed is:

1. A system for monitoring operation of a locomotive having a main internal combustion engine and an auxiliary internal combustion engine, said system comprising:
(a) means for generating position data for the locomotive;
(b) means for generating auxiliary engine data concerning operation of the auxiliary engine relative to the position data;
(c) means for generating main engine data concerning operation of the main engine relative to the position data; and
(d) storage means for storing the main engine data relative to the position data and the auxiliary engine data relative to the position data.

2. The system of claim 1, wherein the means for generating position data includes a satellite global positioning system (GPS) comprising:
(a) an antenna in communication with said satellite; and
(b) a receiver in communication with said antenna.

3. The system of claim 2, wherein the means for storing the main engine data relative to the position data and the auxiliary engine data relative to the position data is a data recorder coupled to the receiver, the auxiliary engine, and the main engine.

4. The system of claim 1, wherein the means for generating auxiliary engine data and the means for generating main engine data comprise a computer having a plurality of application programs which is coupled to said means for storing.

5. The system of claim 4, wherein said plurality of application programs comprises
(a) at least one of said application programs comprising a fuel manager function that receives and processes information from said means for compiling information to generate figures on fuel consumption by the vehicle;
(b) at least one of said application programs comprising a position/speed manager function that receives and processes information from said means for compiling information to generate figures on the vehicle position and speed; and
(c) at least one of said application programs comprising an emission manager function that receives and processes information from said fuel manager and said position/speed manager to generate figures on the vehicle emission.

6. The system of claim 1 further comprising a means for transmitting said auxiliary engine data concerning operation of the auxiliary engine relative to the position data to a user.

7. The system of claim 1 further comprising a means for transmitting said main engine data concerning operation of the main engine relative to the position data to a user.

8. The system of claim 7, wherein said means for transmitting the operational data of such vehicle comprises a wireless electronic communication device.

9. A method of monitoring operation of a locomotive having a main internal combustion engine and an auxiliary internal combustion engine, said method comprising the steps of:
(a) generating position data for the locomotive;
(b) generating auxiliary engine data concerning operation of the auxiliary engine relative to the position data;
(c) generating main engine data concerning operation of the main engine relative to the position data;
(d) storing the main engine data relative to the position data and the auxiliary engine data relative to the position data; and
(e) computing said stored main engine data relative to the position data and the auxiliary engine data relative to the position data for use in a plurality of functions.

10. The method of claim 9, wherein the step of generating position data includes a satellite global positioning system (GPS) comprising:
(a) an antenna in communication with said satellite; and
(b) a receiver in communication with said antenna.

11. The method of claim 10, wherein the step of storing said main engine data relative to the position data and the auxiliary engine data relative to the position data is performed by a data recorder coupled to said receiver, the auxiliary engine, and the main engine.

12. The method of claim 9 further comprising the step of communicating said position data for the locomotive.

13. The method of claim 12, wherein the step of communicating said position data is performed with a wireless communication device.

14. The method of claim 9, wherein the plurality of functions comprise:
(a) a fuel manager function that receives and processes information from said stored main engine data relative to the position data and the auxiliary engine data relative to the position data to generate figures on fuel consumption by the locomotive;
(b) a position/speed manager function that receives and processes information from said stored main engine data relative to the position data and the auxiliary engine data relative to the position data to generate figures on the locomotive position and speed; and
(c) an emission manager function that receives and processes information from said fuel manager and said position/speed manager to generate figures on emission from said locomotive.
